(19) United States
(12) Patent Application Publication
(10) Pub. No.: US 2022/0242293 A1
(43) Pub. Date: Aug. 4, 2022

(54) Compactable Mattress and Method

(71) Applicant: Top Vision Group B.V., Haarlem (NL)

(72) Inventor: Omar Tegel, Haarlem (NL)

(21) Appl. No.: 17/622,331

(22) PCT Filed: Jun. 30, 2020
(86) PCT No.: PCT/NL2020/050431

§ 371 Date: Dec. 23, 2021

(30) Foreign Application Priority Data
Jun. 30, 2019 (NL) 2023410

(51) Int. Cl. B60N 3/00; A47C 27/15

(52) U.S. Cl. CPC B60N 3/008; A47C 27/15

(57) ABSTRACT

The present invention relates to a compactable mattress for use on a predetermined arrangement surface. The compactable mattress may include: a support layer and a comfort layer, arrangeable at the support layer. The support layer may be provided with a predetermined underside shape for shape adjustable arrangeability relative to the predetermined arrangement surface. The support layer may be provided with a predetermined topside shape for arranging thereof of the comfort layer. The support layer may be transformable between a state of use and a compacted state.

### CROSS-REFERENCE TO RELATED APPLICATIONS

This application is the United States national phase of International Application No. PCT/NL2020/050431 filed Jun. 30, 2020, and claims priority to The Netherlands Patent Application No. 2023410 filed Jun. 30, 2019, the disclosures of which are hereby incorporated by reference in their entirety.

### BACKGROUND OF THE INVENTION

### Field of the Invention

The present invention relates to a compactable mattress for use on a predetermined arrangement surface preferably in a vehicle, such as a car mattress for use in a car, which is usable as a mattress in a state of use and in a compacted state. Furthermore, the present invention relates to a method for manufacturing of such a compactable mattress.

### Description of Related Art

It is known to apply an air band or a mattress in a vehicle to thereon rest or sleep. A problem with this is that, with the exception of some models of such vehicles, the loading surface of a vehicle, such as a passenger car, mostly doesn't have a flat support surface. The reason for this is that the loading surface of a vehicle, such as in particular a private vehicle or passenger car, is generally shaped by a combination of a loading surface of a trunk and a surface or support surface formed by a folded down rear seat. As a consequence, the surface on which a mattress should be arrangeable for resting or sleeping thereon is formed with humps, pits, cusps, recesses, tapers and broadenings that substantially cause a lack of comfort.

### SUMMARY OF THE INVENTION

In order to provide an improvement, the present invention provides a compactable mattress for use on a predetermined arrangement surface preferably in a vehicle, such as a car mattress for use in a car, which is usable as a mattress in a state of use and in a compacted state, wherein the compactable mattress comprises:
a support layer for supporting on the predetermined arrangement surface formed by surface features of the vehicle, such as formed by a loading surface of a car preferably in combination with a surface of a downwardly folded rear seat,
a comfort layer for providing comfort for lying to a person, which is arrangeable or is arranged at the support layer, wherein:
the support layer is provided with, with an in the condition of use, predetermined underside shape for substantially shape adjustable arrange ability relative to the predetermined arrangement surface,
the support layer is provided with a, in the state of use, predetermined topside shape for arranging thereof of the comfort layer, and
wherein the support layer is transformable between the state of use and the compacted state.

An advantage that is provided by the present invention is that a comfortable place of rest or place for sleeping is provided on or relative to the arrangement surface as shaped by the loading floor of a car, preferably in combination with a surface of the downwardly folded rear seat.

In an advantageous manner, a compactable mattress is provided that is storable in a compacted state while it provides a very comfortable place of rest or place for sleeping in the state of use wherein it takes up a large volume.

With this, a mattress is advantageously provided that can be easily taken along and stored in a vehicle which provides the user with a preferably flat support surface for the comfort layer that is defined by the predetermined topside shape. With this, the comfort layer provides a comfortable place of rest or place of sleep without bumps or pits that are formed by the humps, pits, cusps, recesses, tapers and broadenings such as our present in for example an arrangement surface formed by a loading surface of a trunk and a folded down rear seat of a car.

With the present invention, it is provided to overcome height variations with a thickness of several centimeters to a thickness of several decimeters, that is to support with it. A high difference of for example several centimeters to well over 10 cm is for instance present in car model Tesla™ 3, subsequently decreasing to several centimeters and subsequently increasing to over 15 cm, with therein furthermore a recess. The part with a thickness of several centimeters may within the understanding of the present invention freely fillable by making for example the height of the whole topside shape higher and there with the support layer fully thicker. Of relevance for the present invention is providing of a level topside shape.

This is preferably realized by inflating of the support layer with a high pressure because of which these support layer is relatively hard which also allows the level topside shape under a load. The gas pressure in the support layer is here with considered between one and for example 10 bar, such as between one and a half and 8 bar, such as between toolbar and 5 bar, such as between one bar and toolbar, such as between toolbar and 3 bar, such as between 3 bar and 4 bar, such as between 4 bar and 5 bar. The gas pressure in the comfort layer is preferably less in line with a requirement of the user less than one bar without load, up to a comparable air pressure with a firm the inflated air bed. In the variant with a foam body air pressure by inflation is alternatively refrain from other than that is realizable by expansion of the foam, alternatively with closing of a nipple. With a relatively hard support layer, a stretch ability of the top side of the support layer is prevented for the purpose of preventing thing of feeling of bumps or humps in the arrangement surface that reach close to the top side of the support layer.

According to a first preferred embodiment, the topside shape of the support layer is defined as substantially flat. With this, a substantially flat or level support surface for the comfort layer is provided in there with a level playing surface for resting or sleeping. In the context of this document, substantially flat means that a general support plane is defined. This encompasses, according to the present invention, any hump or cusp pattern such as is per se known from mattresses or air beds according to the state-of-the-art. Also with such a hump or cusp pattern, the function of the support layer according to the present invention is fulfilled. The general point is to compensate for irregularities in the arrangement surface.

According to a further preferred embodiment, the comfort layer is transformable between the state of use and the compacted state. With this, in a practical manner, a volume difference is realized between the compactable mattress in the state of use and the compacted state. With this, the compactable mattress is advantageously compactly storable in a vehicle for taking along of it.

Further preferably, the support layer is inflatable by means of a gas, such as air, and/or wherein the comfort layer is inflatable by means of a gas, such as air, or wherein the comfort layer comprises a foam layer that is compressible, such as by means of forcing air out the foam layer and letting air into the foam layer. A maximum volume difference is here with realizable for the support layer as well as for the inflatable comfort layer. For the variant with the comfort layer comprising a foam layer, a comfort level is realized by means of the foam layer while maintaining a large volume difference between the state of use and the compacted state of the comfort layer.

Further preferably, the support layer is provided with contour definition means defining the predetermined underside shape of the support layer relative to the topside shape in the state of use, the contour definition means preferably comprising a separation wall, a spacer, a web or a wraparound element. With such contour definition means the distance to be realized between the topside shape and the underside shape may be realized at any location in top view. For the purpose of a specific instance of a predetermined arrangement surface, a fitting, possibly complex, shape may thereby be realized. With this, variations in height of the arrangement surface are advantageously compensated for.

According to a further preferred embodiment, the support layer embodied as an air chamber or a combination of air chambers, there with defining the predetermined underside shape of the support layer, preferably comprising a support layer topside defining the predetermined topside shape, a support layer underside defining the underside shape, preferably comprising at least one shape definition member, such as a connection means between the support layer topside and the support layer underside. By means of such air chambers a variation in height between the top side of the support layer and the underside of the support layer is advantageously definable. With this, it i may be realized that the support layer is suitable for supporting on the predetermined arrangement surface. Several air chambers may be filled with a different air pressure, such as a predetermined different air pressure for realizing of the topside shape of the support layer.

Further preferably, the support layer comprises the combination of air chambers, preferably in a position arranged in the vehicle horizontally and/or vertically relative to each other, adjacent to each other, arranged for shaping of the support layer with the predetermined topside shape and the predetermined underside shape in combination thereof.

According to a further preferred embodiment, the comfort layer comprises a foam element, preferably an open celled foam element. With this, the comfort layer provides an additional comfort aspect relative to an airfield chamber. The foam element may be provided as a self inflatable element, such as itself known in the art, or as an element that is provided with volume or from which volume is taken by means of air pressure. Alternatively, the volume is reduced by for example rolling up of the foam element.

According to a further preferred embodiment, the compactable mattress comprises a tick encasing the comfort layer and/or the comfort layer in combination with the support layer. By means of such a take an advantageous appearance is provided bulk to the compactable mattress. Furthermore, additional comfort is provided by a choice of material of a tick. Furthermore, a tick protects that which is arranged in the tick. Furthermore a tick is cleanable separately of what is arranged in the tick during use and/or storage.

Further preferably, the compactable mattress comprises a control layer for providing of aeration and/or moist regulation, preferably comprised in the tick, further preferably removably comprised in the tick. With this, a high level of comfort is realized. The aeration and/or moist regulation is provided will by means of a very open celled foam or for example a 3D mesh applicable in pillows and/or mattresses, the 3D mesh comprising a top layer, a bottom layer with bars or fibers extending therebetween of which the ends are arranged in the top layer and the bottom layer. Such a material is in itself known in the art of mattresses.

According to a further preferred embodiment, the compactable mattress comprises fastening means for mutually fastening of the support layer relative to the comfort layer, the fastening means preferably comprising friction means preventing lateral movement, hook and loop means, cord, pushbuttons and/or a zipper. With this, it is advantageously realizable to keep the support layer and the comfort layer together during for example placement and storage thereof, as well as during use as mattress.

Further preferably, the compactable mattress comprises a cover layer of stretchable material, such as a 30D soft stretch polymer, at the top side of the comfort layer or the tick. With this, next to a general advantages of the tick, additional comfort is provided to the comfort layer.

According to a further preferred embodiment, an encasing of the support layer comprises substantially nonstretchable materials as wall material or as reinforcement of wall material for the purpose of dimensional stability relative to the shape adjustable arrangeability, such as comprising canvas or nylon with for example a polyurethane inner coating. With this, the dimensional stability and there with the predetermined topside shape of the support layer is further improved. For the purpose of providing of in particular a flat topside shape for arranging thereon of the comfort layer, it is advantageous that a relatively high gas pressure at the inside of the support layer may be realized, in particular in cases in which bumps or humps are present are present in the arrangement surface. Feeling of such bumps or humps is here with advantageously better prevented.

For providing of a lengthened compactable mattress relative to the arrangement surface, a further preferred embodiment provides in the support layer a front side support part for the purpose of supporting against a front side of a folded down rear seat, a topside thereof forming a part of the topside shape. With this, the front side of a counterforce is advantageously provided by the front side of the downwardly folded rear seat holding up the front side support part because of which this front side support part provides a part of the topside shape and there with the top side of the support layer.

Further preferably, in top side view, the mattress has a shape for fitting in a contour shape, such as the inner side of the vehicle, at the location of the arrangement surface. With this, it is realized that the mattress is fixed by means of the contour shape, such as that of the inner side of the vehicle. Alternatively, it is provided that the mattress fills a part of the contour. With this, it is realized that example more luggage can be taken along.

According to a further preferred embodiment, the compactable mattress comprises an air pump for pumping of air into the support layer and/or the comfort layer for transformation thereof to the state of use and/or pumping of air out of the support layer and/or the comfort layer for transformation thereof to the compacted state. With this, it is advantageously realized that such pumping in and pumping out may be performed in a mechanical manner. Alternatively, it is for example possible to perform pumping out by means of folding or rolling up of the compactable mattress, or to pump in error by means of mouth force. Preferably, an electrical pump is provided.

Further preferably, the mattress comprises distribution means for distribution of the input and/or output of air between the support layer and/or the comfort layer, preferably for achieving of a functional pressure in each thereof, preferably with a relatively high pressure providing the topside shape for the support layer and/or with a relatively low pressure providing comfort to the comfort layer. With this, a difference in air pressure is achievable between several parts of the support layer relative to each other and between the support layer and the comfort layer.

Further preferably, the topside shape is defined such that during use, such as when the mattress is arranged against the arrangement surface, it is substantially arranged horizontally relative to gravity. Such arrangement is determined by the predetermined arrangement surface and to shape thereof and the position thereof relative to the gravity.

Further preferably, the compactable mattress is embodied in two parts in top view, preferably in the lengthwise direction, such as with a width ratio of one third relative to two thirds or a width ratio of 40% relative to 60%. With this, it is advantageously realized that distinct able mattress parts are placeable. Furthermore, it is advantageously realized that users have a larger independence of each other.

Further preferably, the compactable mattress has a shape in the compacted state that is suitable for arrangement in a storage space of the vehicle. With this, the compactable mattress, next to an adaptation according to the present invention to the arrangement surface and/or to a contour in top view of the inner space of a vehicle, is adapted to a specific storage space of a specific vehicle, wherein in combination with the vehicle, and optimal solution is provided according to the present embodiment.

Further preferably, the compactable mattress is arrangeable in a storage space of the vehicle, wherein it is coupled with the pump for folding out of the compactable mattress by means of expansion force based on air pressure from the pump onto the arrangement surface and until the state of use is attained, preferably wherein by means of suction power of the pump, the compacted state is achieved by pumping out of air. With this, a variant is provided wherein automatic transfer to the state of use may be practically realized by simply switching on of a pump. Further preferably, fully or partially automatically transferring to the compacted state and/or a folded compacted state is realized. Manual folding after pumping out of air is as much provided.

Further preferably, the compactable mattress comprises crease lines or folding lines for folding of the mattress there along during transfer of the mattress between the state of use and the compacted state. Such crease lines or folding lines are preferably provided of a visible marketing for the purpose of folding.

A further aspect according to the present invention provides a method for manufacturing of a compactable mattress according to one or more of the preceding claims or a car mattress, the method comprising steps of:
determining or receiving of the shape of a predetermined arrangement surface for placement thereof of a support layer of the compactable mattress;
determining or receiving of the shape of an underside shape of the support layer;
determining or receiving of the shape of the support layer including topside shape in the state of use;
determining or receiving of contour definition means defining the predetermined underside shape of the support layer relative to the topside shape in the state of use and/or determining of a shape of a combination of air chambers;
determining of the support layer on the basis of the determined shape of the arrangement surface, the determined shape of the underside shape, the determined shape of the support layer including topside shape in the state of use and the determined contour definition means. Next to the advantages provided by the previous aspect, the present aspects provides an optimal adjustment of the compactable mattress to a predetermined arrangement surface, optionally combined with an internal contour of the vehicle.

According to a preferred embodiment, the method comprises steps of assembly of the comfort layer, preferably comprising steps for joining of the support layer and the comfort layer.

### BRIEF DESCRIPTION OF THE DRAWINGS

Further advantages, features and details of the present invention will be further elucidated on the basis of a description of one or more preferred embodiments with reference to the accompanying figures. Similar yet not necessarily identical parts of different preferred embodiments may be indicated with the same reference numerals.

FIG. 1A shows a top view of a support layer according to a first preferred embodiment according to the present disclosure;

FIG. 1B shows a first side view of the support layer of FIG. 1A;

FIG. 1C shows a bottom view of the support layer of FIG. 1A;

FIG. 1D shows a section view taken along the line I-I in FIG. 1C;

FIG. 1E shows a perspective view of the support layer of FIG. 1A;

FIG. 1F shows a second side view of the support layer of FIG. 1A;

FIG. 2A shows a first side view of a comfort layer according to another preferred embodiment according to the present disclosure;

FIG. 2B shows a top view of the comfort layer of FIG. 2A;

FIG. 2C shows a second side view of the comfort layer of FIG. 2A;

FIG. 2D shows a bottom view of the comfort layer of FIG. 2A;

FIG. 2E shows a first perspective view of the comfort layer of FIG. 2A;

FIG. 2F shows a second perspective view of the comfort layer of FIG. 2A;

FIG. 3 shows a perspective exploded view of a further preferred embodiment according to the present disclosure;

FIG. 4 shows a perspective exploded view of a further preferred embodiment according to the present disclosure; and

FIG. 5 shows a perspective view of an arrangement surface with a preferred embodiment according to the present disclosure.

### DETAILED DESCRIPTION OF THE INVENTION

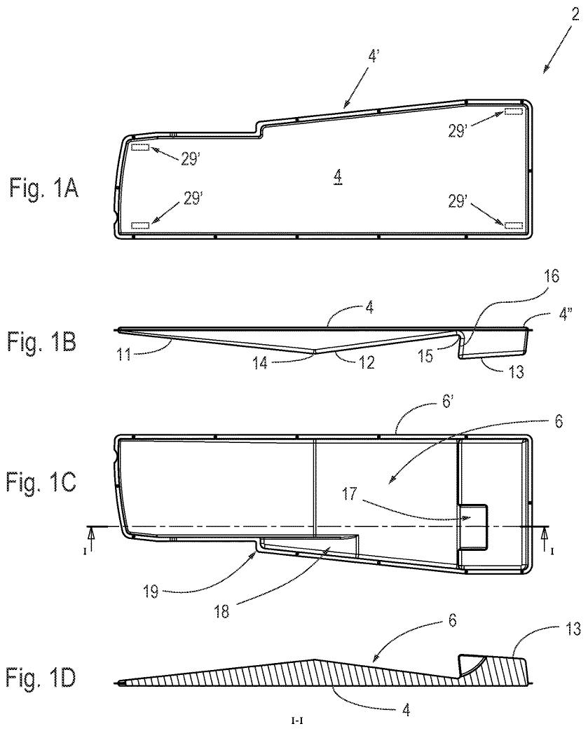

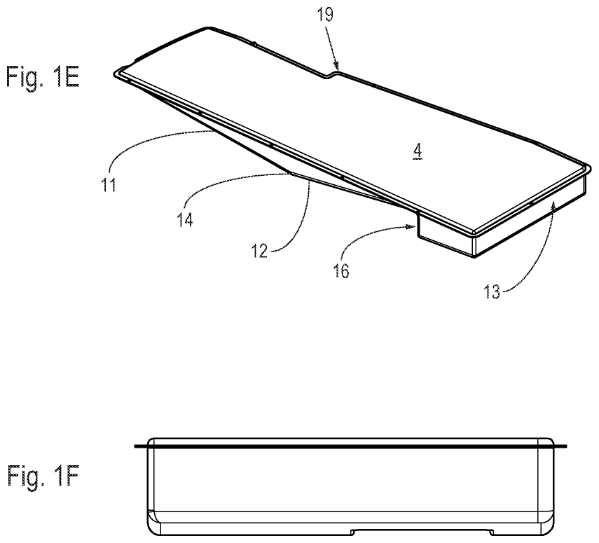

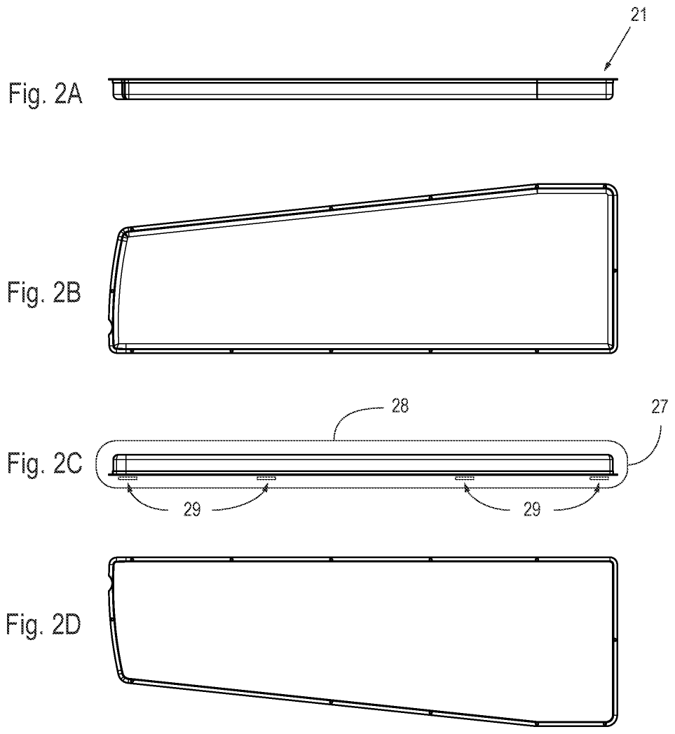

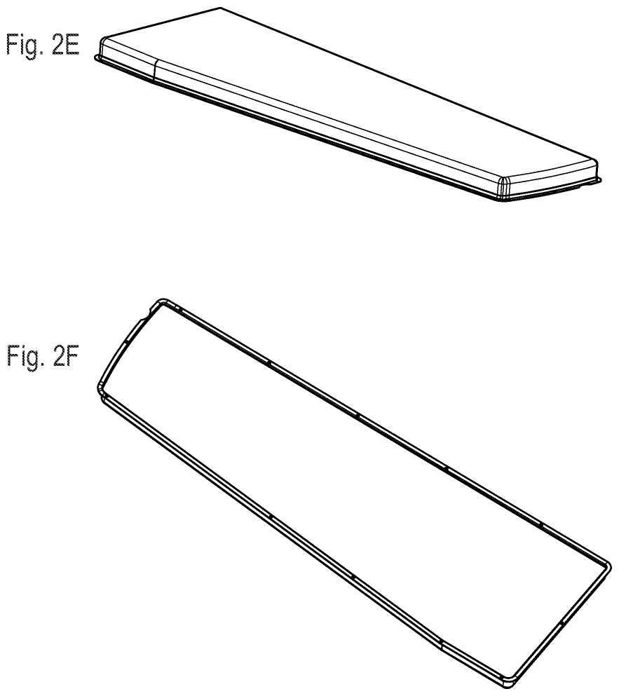

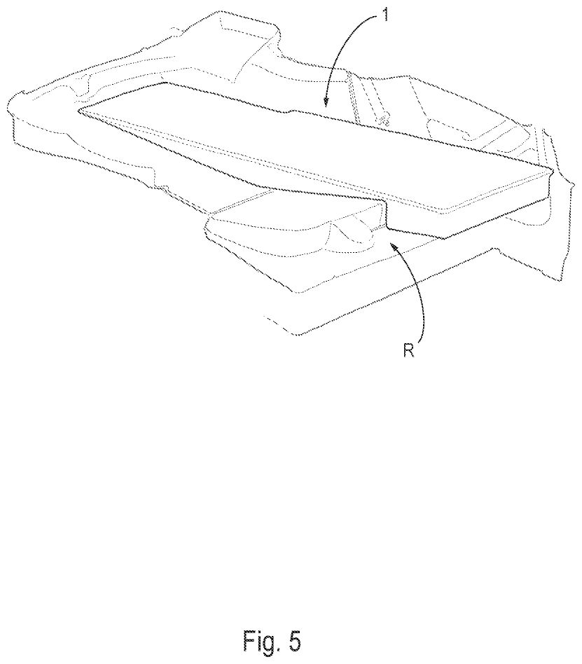

A first preferred embodiment (FIGS. 1A-1F) according to the present invention relates to a compactable mattress 1. It comprises a support layer 2 with a flat topside 4 with a topside shape 4′ and an arrangement surface R of a car (FIG. 5). The underside 6 of the support layer 2 has an underside shape 6′ that is adapted to fit with the arrangement surface. This adaption of the shape is readily visible in the bottom view of FIG. 1C, the side view of FIG. 1 B and the section view of FIG. 1D.

From the rear side of the car, a slope 11 extends downwardly to a top 14 after which the slope 12 extends upwardly to a corner 15. Subsequently an extending part 13 is arranged near the end of the compactable mattress. This extending part 13 extends beyond the downwardly folded rear seat until the front seats of the car (not shown). While part 16 of the extending part 13 hereby pushes against the downwardly folded rear seat in order to find support against this for upwardly holding of the end part 4″ of the flat upper side 4 of the support part. Furthermore, a recess 17 is provided for taking in of the head support of the downwardly folded rear seats. In a recess 18 for taking in of a further irregularity in the arrangement surface of the car laterally.

Glued in parts and intermediate walls are furthermore provided in the support layer for providing of the bottom and the top side. Air nipples are provided at the right side arranged at the rear passenger door of the vehicle. An inlet nipple and an outlet nipple is provided. By means of a manual or electrical pump, of which predetermined pump pressure values are preferably settable, the mattress is pumped. Preferably, for folding of the mattress, the mattress is pumped to emptiness such that the required storage space is minimized.

The comfort layer 21 is a layer that is arranged on the topside 4 of the support layer. This comfort layer generally relates to an air bed or a mattress or a self inflatable mattress for providing comfort relative to the hard support layer 2. Optionally, hook and loop means 29 are provided in cooperation with hook and loop means 29′ of the support layer for fastening. Furthermore, an optional zipper is provided along the edges of the support layer and the comfort layer for fastening. Furthermore, a ticket 27 is provided that is further preferably provided with a comfortable material 28 as interface between the comfort layer and the user.

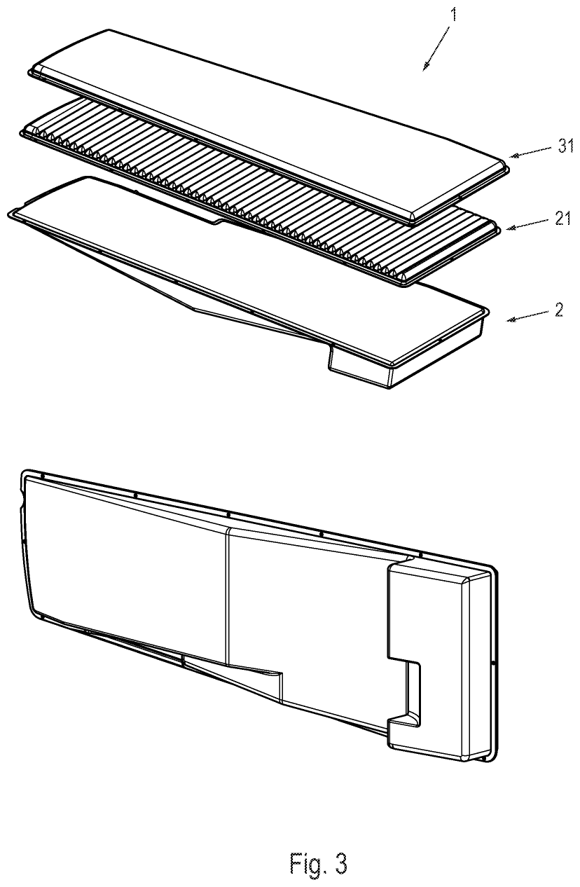

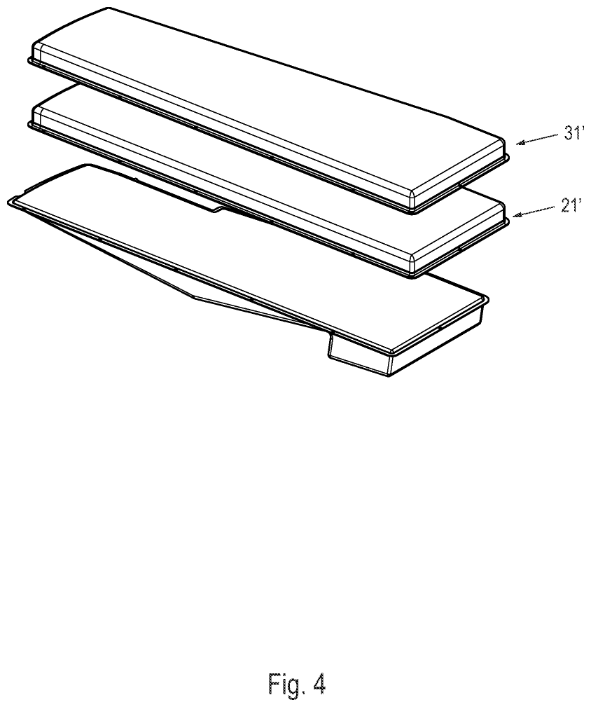

In the variant according to FIG. 3, a control layer 31 is further provided providing aeration and/or market regulation for the compactable mattress. This layer is arranged on the comfort layer. Alternatively, this layer is herewith integrated. It is herewith provided that both these layers each have a separate tick 29 or are arranged together in a single tick. Alternatively, it is provided that a tick is provided around both the support layer, the comfort layer and the control layer. In this variant, the comfort layer 21 is embodied as an air bed.

In the variant according to FIG. 4, the comfort layer is embodied as a foam element holding self inflatable mattress 21′ with a relatively large thickness. On top of that, a control layer 31′ is arranged with a 3D mesh providing moist regulation therein.

Furthermore, it is envisioned that the compactable mattress is suitable for any irregularly shaped arrangement surface for which a mattress solution and/or a temporary mattress solution is needed. To this end, no reference to a feature of a vehicle is required.

The present invention is described in the foregoing on the basis of preferred embodiments. Different aspects of different embodiments are expressly considered disclosed in combination with each other and in all combinations that on the basis of this document, when read by a skilled person of the area of skill, fall within the scope of the invention or are deemed to be read with the disclosure of this document. These preferred embodiments are not limitative for the scope of protection of this document. The rights sought are defined in the appended claims.

1. A compactable mattress configured for use on a predetermined arrangement surface, wherein the compactable mattress comprises:
a support layer for supporting on the predetermined arrangement surface, the support layer formed by surface features; and
a comfort layer for providing comfort for lying to a person, the comfort layer being configured to be arranged at the support layer, wherein:
the support layer is provided with a predetermined underside shape for substantially shape adjustable arrange-ability relative to the predetermined arrangement surface,
the support layer is provided with a predetermined topside shape for arranging the comfort layer thereof, and
the support layer is transformable between a state of use and a compacted state.

2. The compactable mattress according to claim 1, wherein the topside shape of the support layer is flat.

3. The compactable mattress according to claim 1, wherein the comfort layer is transformable between the state of use and the compacted state.

4. The compactable mattress according to claim 1, wherein the support layer is inflatable by means of a gas, or wherein the comfort layer is inflatable by means of a gas, or wherein the comfort layer comprises a compressible foam layer.

5. The compactable mattress according to claim 1, wherein the support layer is provided with contour definition means defining the predetermined underside shape of the support layer relative to the topside shape in the state of use, the contour definition means comprising a separation wall, a spacer, a web or a wraparound element.

6. The compactable mattress according claim 1, wherein the support layer comprises at least one air chamber, the at least one air chamber defining the predetermined underside shape of the support layer, the support layer further comprising a support layer topside defining the predetermined topside shape, a support layer underside defining the underside shape, and at least one shape definition member.

7. The compactable mattress according to claim 6, wherein the support layer comprises a combination of air chambers adjacent to each other, the combination of air chambers being arranged for shaping of the support layer with the predetermined topside shape and the predetermined underside shape in combination thereof.

8. The compactable mattress according to claim 1, wherein the comfort layer comprises a foam element.

9. The compactable mattress according to claim 1, comprising a tick encasing the comfort layer or encasing the comfort layer and the support layer.

10. The compactable mattress according to claim 1 comprising a control layer for providing of aeration and/or moist regulation.

11. The compactable mattress according to claim 1 comprising fastening means for mutually fastening the support layer relative to the comfort layer, the fastening means comprising friction means preventing lateral movement, hook and loop means, cord, pushbuttons and/or a zipper.

12. The compactable mattress according to claim 1 comprising a cover layer of stretchable material at the top side of the comfort layer.

13. The compactable mattress according to claim 1, wherein an encasing of the support layer configured to provide dimensional stability relative to the shape adjustable arrange ability comprises substantially nonstretchable materials as wall material or as reinforcement of wall material.

14. The compactable mattress according to claim 1, wherein the support layer comprises a front side support part for the purpose of supporting against a front side of a folded down rear seat, a topside thereof forming a part of the topside shape.

15. The compactable mattress according to claim 1, wherein in a top side view, the mattress has a shape for fitting in a contour shape at the location of the arrangement surface.

16. The compactable mattress according to claim 1 comprising an air pump for pumping of air into the support layer and/or the comfort layer for transformation thereof to the state of use and/or pumping of air out of the support layer and/or the comfort layer for transformation thereof to the compacted state.

17. The compactable mattress according to claim 16 comprising distribution means for distribution of an input and/or an output of air between the support layer and/or the comfort layer.

18. The compactable mattress according to claim 1, wherein the topside shape is defined such that during use the topside shape is arranged horizontally relative to gravity.

19. The compactable mattress according to claim 1 comprising a width ratio of one third relative to two thirds or a width ratio of 40% relative to 60%, when seen in a top view.

20. The compactable mattress according to claim 1, wherein, in the compacted state, the compactable mattress comprises a shape configured to allow the compactable mattress to be arranged in a storage space of a vehicle.

21. The compactable mattress of claim 1 comprising crease lines or folding lines for folding of the mattress there along during transfer of the mattress between the state of use and the compacted state.

22. (canceled)

23. A method for manufacturing of a compactable mattress according to claim 1, the method comprising steps of:
determining or receiving of the shape of a predetermined arrangement surface for placement thereof of the support layer of the compactable mattress;
determining or receiving of the shape of an underside shape of the support layer;
determining or receiving of the shape of the support layer including a topside shape in the state of use;
determining or receiving of contour definition means defining the predetermined underside shape of the support layer relative to the topside shape in the state of use and/or determining of a shape of a combination of air chambers;
determining of the support layer on the basis of the determined shape of the arrangement surface, the determined shape of the underside shape, the determined shape of the support layer including topside shape in the state of use and the determined contour definition means.

24. The method according to claim 23 comprising the steps of:
assembling the comfort layer; and
joining the support layer and the comfort layer.
